(19) United States
(12) Patent Application Publication
(10) Pub. No.: US 2026/0006072 A1
(43) Pub. Date: Jan. 1, 2026

(54) MALICIOUS WEBSITE DETECTION USING INTERMEDIATE REPRESENTATIONS

(71) Applicant: Email Veritas Security Technologies Inc., Victoria (CA)

(72) Inventors: William Ryan Briguglio, Victoria BC (CA); Issa Traore, Victoria BC (CA); Marcelo Luiz Brocardo, Florianópolis (BR)

(73) Assignee: Email Veritas Security Technologies Inc., Victoria, BC (CA)

(21) Appl. No.: 18/755,300

(22) Filed: Jun. 26, 2024

(51) Int. Cl. H04L 9/40

(52) U.S. Cl. CPC H04L 63/1483

(57) ABSTRACT

Websites are classified based on intermediate representations of the associated source code using a machine learning model applied to a set of intermediate representations from websites having predetermined classifications. The use of intermediate representations can provide a machine independent classifier that does not required use of lists of websites known to be malicious. The intermediate representation-based classifier can be combined with URL and HTML based classifiers, including classifiers that incorporate URLs that are both statically and dynamically linked.

### FIELD

The disclosure pertains to the identification of malicious websites.

### BACKGROUND

Automatically detecting malicious websites is an urgent problem with a wide assortment of approaches. However, the performance of standard approaches leaves much to be desired. The most common technique used is blacklisting, in which a list of known malicious URLs is maintained. Blacklists cannot contain an exhaustive list of all malicious URLs and therefore suffer from an inability to generalize to previously unseen URLs. Other techniques analyze the content (i.e., structure, syntax, and semantics) of URLs themselves, with some success, but too little information is contained in the URL, so they also suffer from low accuracy on unseen URLs. More advanced approaches analyze the content within webpages pointed to by URLs. However, here the opposite problem persists, there is too much data. The HTML and JavaScript used in webpages contain near endless variation, much of which is arbitrary and does not affect the appearance, let alone the functionality, of the webpage. Even if only the JavaScript within a webpage is examined, this JavaScript contains near endless variation, much of which is arbitrary. Approaches which leverage such data struggle to adequately learn which variations are meaningless and attach too much significance to unimportant features. In order to properly address all such variation, massive amounts of data would need to be collected, and this collection would need to expand to cover new techniques as attackers adapt their methods. A data collection task with such a large scope is often unfeasible in practice. In view of the shortcomings of these and other conventional techniques, improved approaches are needed.

### SUMMARY

In the disclosed approaches, the amount of possible variation a machine learning (ML) model must handle when analyzing response content to categorize as malicious or harmless is reduced by applying separate models to raw HTML from a web page (with script elements removed) and high level programming language instructions such as those in the JavaScript programming language instructions contained in responses to interactions with a website. These high level programming language instructions are analyzed to produce an intermediate representation which is machine independent and contains less variation that is unrelated to performance. For example, JavaScript instructions can be analyzed to produce bytecode to reduce or eliminate unnecessary (and often meaningless) detail. The bytecode produced from the JavaScript instructions is machine independent and can be translated for execution into machine code for particular machines.

The foregoing and other objects, features, and advantages will become more apparent from the following detailed description, which proceeds with reference to the accompanying figures.

### BRIEF DESCRIPTION OF THE DRAWINGS

FIG. 1 illustrates a representative method of developing a machine learning (ML) algorithm for identifying malicious web pages using an intermediate representation of a web page source program.

FIG. 2 illustrates a representative method of identifying a malicious web page based on an intermediate representation of a web page source program using an ML algorithm developed according to FIG. 1.

FIG. 3 illustrates a representative method of processing an intermediate representation such as JavaScript programming language-based bytecode in identifying malicious web pages.

FIG. 4A illustrates a representative portion of a JavaScript language program portion for a web page source program.

FIG. 4B illustrates an intermediate representation (bytecode) of the JavaScript language program portion shown in FIG. 4A annotated to illustrate assignment into 6-channel, two dimensional images.

FIG. 4C illustrates assignment of the bytecode of FIG. 4B into 6-channel, two dimensional images for use in malicious web page detection.

FIG. 5 illustrates a representative method of classifying a website with URL, intermediate representation, and HTML-based classifiers.

FIG. 6 illustrates a representative method of determining an ML classifier based on static and dynamic URLs associated with a website.

FIG. 7 illustrates a representative method of determining an ML classifier using website HTML sequences.

FIG. 8. illustrates a general computing environment for use with the disclosed approaches.

FIG. 9 includes a Table illustrating the effectiveness of the disclosed approaches in malicious web page detection.

### DETAILED DESCRIPTION

### Introduction and Definitions

The disclosed approaches pertain to malicious website identification (or other identifications of problematic computer programs) by using intermediate representation(s) of the source code that defines website. Intermediate representations contain less detail than the source code and thus reduce the otherwise substantial amount of variation that is unrelated to malicious website identification. The use of intermediate representations also permits generalization to new and untested source code associated with arbitrary URLs and thus avoids problems associated with lists of problematic websites. The examples of the disclosed approaches are generally based on machine learning (ML) classification using one or more of a (1) a JavaScript bytecode-based classifier (bytecode serving as an exemplary intermediate representation), (2) a JavaScript source URL-based classifier, and (3) an HTML-based classifier.

The examples discussed are generally directed to website characterization as harmless or malicious but the disclosed approaches can be used in other classifications. As used herein, a “web page” refers to computer executable instructions accessible via a Uniform Resource Locator (URL) and “website” refers generally to computer-executable instructions and the associated URL. Computer-executable instructions for web pages are typically provided in one or more human readable programming languages such as the JavaScript programming language (hereinafter “JavaScript”) and the HTML programming language (sometimes referred to as a mark-up language). The disclosed approaches are generally applicable to URLs based on other programming) languages, but the examples below refer to the JavaScript programming language for convenient illustration and in view of its extensive use. As noted above, the disclosed approaches can be used to characterize computer-executable instructions associated with websites or other applications such as macros in office applications (word processing and spreadsheets) or other applications whether used by mobile devices such a phones, tablets, laptops, or desktops, or other fixed or mobile processing devices. For convenience, as used herein, “website” refers to a single web page and a set of web pages addressed via a common URL.

“Computer-executable instructions” as used in herein includes source code, machine code, and intermediate code referred to generally herein as an intermediate representation. Computer-executable instructions are provided in one or more programming languages that are systems of symbols and characters used to provide instructions to a computer or other logic device for execution. “Program” or “code” refer to a set of instructions in a programming language. In the examples discussed below, programs are associated with URLs and define responses obtained by accessing a URL, typically with a web browser.

As used herein, “source code,” “source program,” and “source” refer to computer-executable instructions for a computer or other logic device written in a human-readable programming language that can be converted into instructions and data for use by the computer or other logic device. This conversion can be performed by an interpreter or compiler to produce hardware-dependent instructions associated with execution on a particular processor or logic device. Hardware-specific sets of instructions are referred to as “machine language” programs. “Intermediate representation” refers to a set of hardware-independent instructions produced by a compiler or interpreter based on source code. An intermediate representation of a source program can be further processed by a compiler or interpreter to produce hardware-dependent code (i.e., a machine language program) for implementation on a particular processor or logic device. Processing of source programs in a human readable programming language to produce an intermediate representation substantially reduces code variability, making evaluation of intermediate representations more feasible, while preserving hardware independence. As noted above, while evaluation of URLs and the associated source code is an important application, source code of other types and for other applications can be similarly evaluated and characterized based on a machine learning applied to intermediate representations of the source code. In addition, while the disclosed examples are based on classification of websites as malicious or harmless, the disclosed approaches can be used to provide other classifications.

In some examples, intermediate representations, HTML, or other character strings are evaluated based on tokens in the character strings, wherein a token is a instance of a sequence of characters that are grouped together as a useful semantic unit for processing. Token can comprise a single character or a sequence of multiple characters.

As used herein, machine learning refers to development of algorithms based on data sets that are often referred to as “training sets.” In most cases, the machine learning algorithms are obtained based on a framework established by a user but without user-selection of framework parameters. In the examples, machine learning algorithms are obtained using training sets to produce one or more algorithms that classify a website based on intermediate representations of the associated source programs. Such machine learning is referred to as supervised learning. In the examples, artificial neural networks are used in which parameters associated with a plurality of interconnected nodes are established using a training set and an objective function. The nodes can be arranged and connected in a variety of ways, typically in multiple layers such as in so-called deep learning. In some cases, some layers of nodes that are intermediate between input and output layer are referred to as hidden layers. One neural network used in the examples is a convolutional neural network (CNN) which is based on one or more convolutional layers, pooling layers, and fully connected layers. Training data can be represented as multi-channel image data thereby permitting use of established image-processing applications. Machine learning can also be applied to website evaluation using URLs such as website HTML sequences.

As used herein, a web browser is a computer program configured to receive and process computer programs and data associated with a URL, typically by querying a website associated with the URL.

For convenient illustration in the examples discussed below, the JavaScript programming language is generally used to define website operation (typically in combination with HTML instructions), and a particular JavaScript engine (the V8 JavaScript engine and its associated Ignition interpreter) associated with a particular web browser (the Chrome web browser in this example) is used. The Chrome web browser uses the V8 Ignition interpreter to convert web page JavaScript instructions (which are human-readable) into an intermediate representation referred to as bytecode. This reduces the variability inherent in the data analyzed by a classification model in three ways. Firstly, human-readable code can contain nearly infinite variation in the function and variable names, whitespace used, and comments alone, without changing the functionality of the code at all. However, in a bytecode representation, all such variability is removed, and only the instructions that are to be executed by the machine on which the web browser (e.g., the Chrome web browser) is running on are retained. Secondly, individual bytecodes can only take on values only in a range [0; 255], whereas each token in a human readable JavaScript code can take on a value in [0; v] where v is the size of the “vocabulary” of all possible characters recognized by a given machine learning model. For HTML-based classification models which use human-readable code as is, such vocabularies can be very large, with v well over 200,000. Thirdly, bytecode generated by the Ignition interpreter differs from executables and machine code, which are also not intended to be human readable, in that the latter are platform-specific, meaning the same source code results in different executables or machine code on different operating systems and devices. The bytecode generated by the Ignition interpreter is the same across different platforms, meaning variation from data gathered on devices that are not exactly the same is removed. Bytecode from a given website's JavaScript source code is provided to an ML model that learns to distinguish benign bytecode from malicious bytecode. An ML model is referred to herein as producing an ML algorithm, ML classifier, or simply a classifier that identifies malicious websites.

As used herein, bytecode refers to an instruction set designed for execution by a software interpreter that is at a level of abstraction between a human readable JavaScript source code and a machine-readable machine code. A bytecode program may be executed by parsing and directly executing the instructions, one at a time, using appropriate machine-dependent instructions. Bytecode can also be referred to as an intermediate code generalization, lacking keys used for readability by humans but independent of machine hardware and the associated instruction set. Bytecode is an example intermediate generalization and is used herein due to its association with a common web browser and this web browser's widespread use.

As used herein compiling refers to transforming source code written in one programming language (a human readable language such as the JavaScript language) into an intermediate programming language (i.e., an intermediate representation such as bytecode).

### Example 1. Web Page Classification Using Intermediate Representations

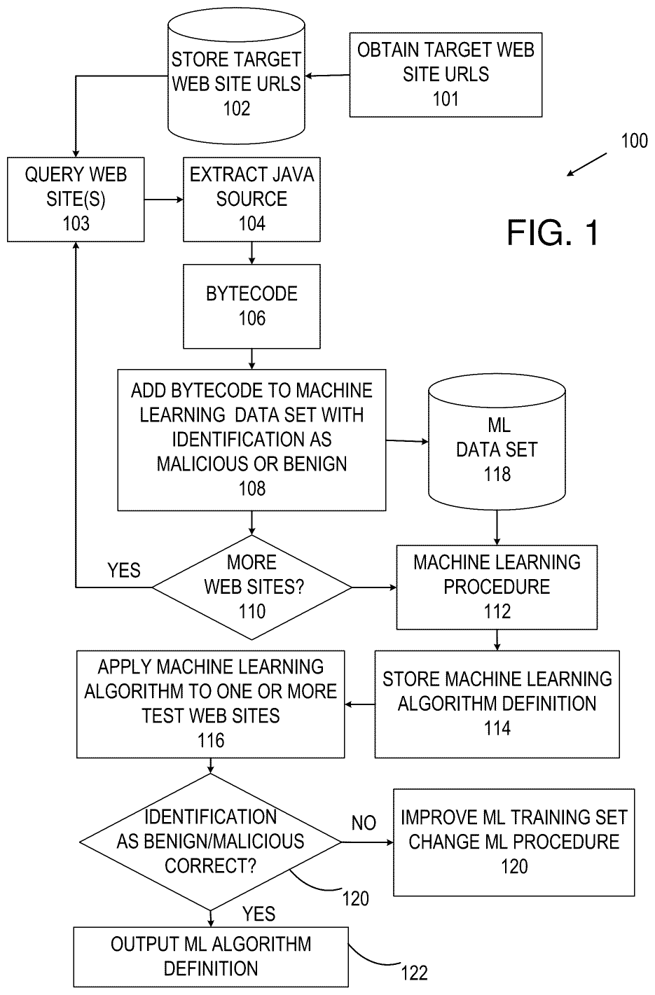

Referring to FIG. 1, a representative method 100 of developing an ML model for discriminating between benign and malicious websites includes identifying a set of target websites at 101, wherein each website of the target websites has a known identification as benign or malicious. This set of target websites is stored at 102, typically using the associated URLs. However, in some cases, source programs from the target set of websites can be obtained and stored based on previous queries of the target websites or otherwise receiving computer programs and/or data associated with the plurality of websites. The set of target websites serves as an ML model training set. Typically, at 103, a web browser is operated to communicate with the plurality of websites and receive associated website source programs and produce corresponding intermediate representations of the source programs. In the example of FIG. 1, after querying a website, a source program in a JavaScript programming language is obtained at 104 and at 106, a corresponding intermediate representation is obtained as bytecode. The bytecode is stored at 108 along with a website identification as benign or malicious in one or more computer readable media 118 as part of a machine learning training set. At 110, it is determined if an additional website of the target websites is to be queried. If so, another website is queried at 103 and the processing is repeated. If complete, a machine learning procedure is implemented at 112 using the machine learning data set stored at 118 to generate a machine learning algorithm that is stored at 114. This machine learning algorithm can be referred to as a website classifier, or more simply, just as a classifier.

Performance of the classifier can be verified by applying the stored machine learning algorithm definition to one or more test websites from the set of target websites at 116. If the test websites are identified correctly as determined at 120, the machine learning algorithm definitions can be output at 122 for further use; if not, the machine learning algorithm can be modified or additional training set data can be supplied and the training process repeated.

The method 100 can be performed with multiple client devices querying selected websites of the set target websites or a single client can query all target websites. In some alternatives, bytecode and/or JavaScript programs (i.e., intermediate representations and source programs) are obtained in some other way and stored for addition to the machine learning data set. In some examples, the target website URLs need not be queried and previously acquired source programs or intermediate representations are used. In view of the changing nature of threats, the ML algorithm can evolve as new websites are added to the training data while other websites are removed. Because intermediate representations are used with an ML algorithm, the ML algorithm is machine-independent and differences in malicious behavior of a web page from machine to machine do not interfere with proper characterization.

### Example 2. Web Page Access Using an Intermediate Representation-Based Classifier

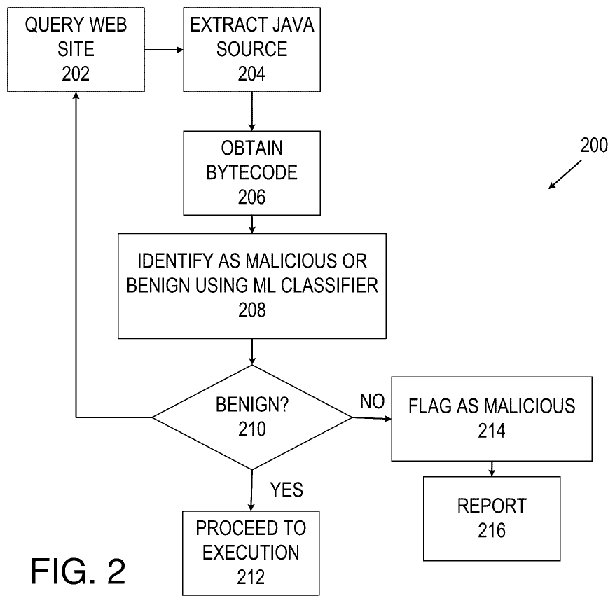

Referring to FIG. 2, a representative method 200 of identifying a website as harmless or malicious includes querying the website at 202 and extracting a source program such as a JavaScript source program at 204. At 206, an intermediate representation is obtained such as bytecode, and at 208, a ML classifier is applied to identify the website as malicious or benign. If benign as determined at 210, the website source program can be executed as 212 and web browsing can continue. If not, the website is flagged as malicious at 214 and can be reported at 216 for further investigation, verification, or to add to ML training data set. As shown in FIG. 2, identifying a malicious website does not require access to list of malicious websites but to an ML classifier trained using known malicious and benign websites. A user accessing an unknown website need not access a database or other list of URLs to determine if the unknown website is malicious but must only have received the ML classifier definition.

### Example 3. Arranging Intermediate Representations for Machine Learning

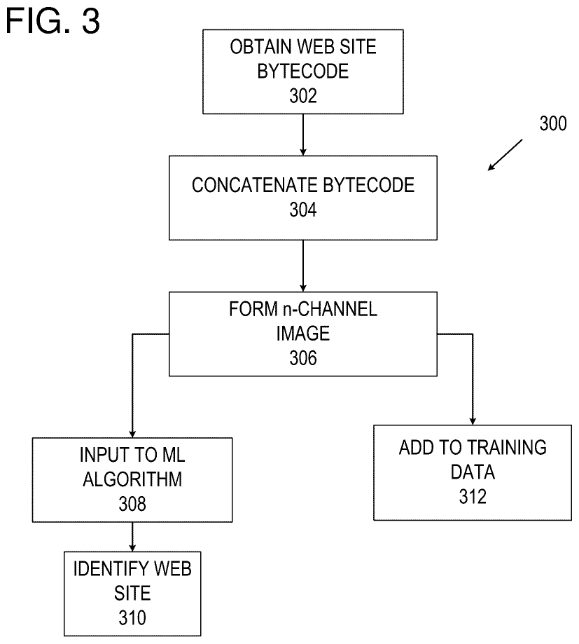

In this example, a convolution neural network (CNN) is used to classify bytecode from a given website. FIG. 3 illustrates a method 300 of processing bytecode from a test website to prepare for determination of an ML classifier or application of a previously determined ML classifier to an untested website. Referring to FIG. 3, the method 300 includes obtaining bytecode associated with the URL/website at 302. In one example, bytecode can be extracted from the URL using a version of a Chrome web browser modified to save bytecode for the selected URL as obtained from the Ignition interpreter when the associated web page is loaded. At 304, the bytecode for the web page is concatenated into a sequence and at 306, this sequence is broken into n-grams wherein n is an integer greater than one. Each n-gram is assigned sequentially to a different element in an array, such as a two dimensional array so that each element of the array has an assigned n-gram. Thus, for example, a two-dimensional array is produced, wherein each element of the array is associated with an n-gram. This arrangement is convenient as it permits ML algorithms to be specified using image processing techniques based on processing of image data provided in two dimensional or other arrays. For convenience such arrays of bytecode are referred to as n-channel images. It will be appreciated that in conventional two dimensional (spatial) images, each element of an image array typical is associated with three or fewer values such as red, green, and blue intensity values, or a single gray level. In determining an ML algorithm it is convenient to use two dimensional n-channel images. These n-channel images can be used in defining the ML algorithm or in identifying a website as harmless or malicious.

### Example 4. n-Channel Images Based on Bytecode

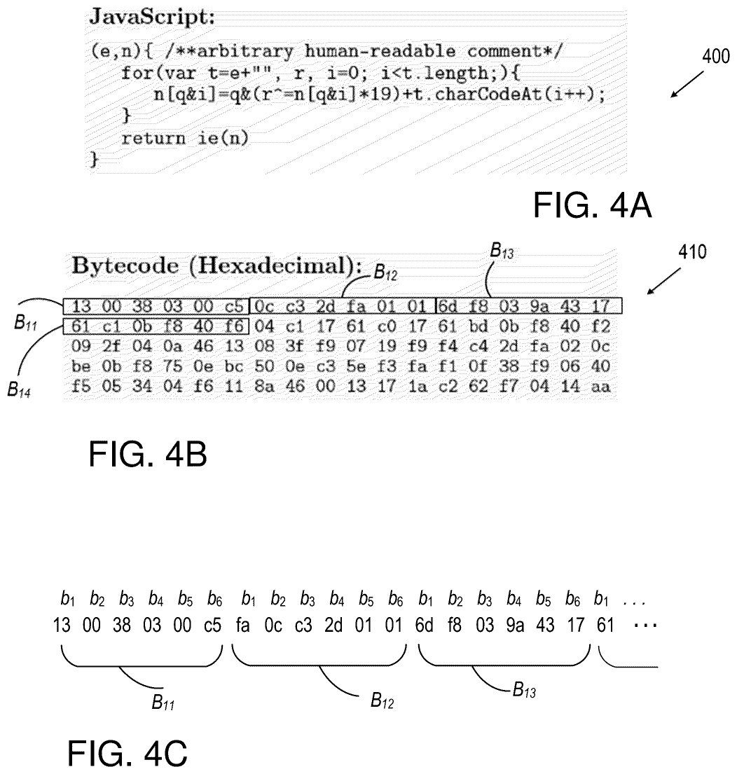

FIGS. 4A-4C illustrate formation of n-channel images using bytecode. FIG. 4A illustrates a representative segment 400 of a JavaScript program and FIG. 4B illustrates associated bytecode 410 expressed in hexadecimal. Sequential values of the bytecode are formed into n-grams to define a two dimensional, n-channel image specified as Bᵢⱼ (b₁, . . . , bₙ) wherein i and j refer to an i^{th} row and a j^{th} location in the associated image array, wherein i=1, 2, . . . , I and j=1, 2, . . . , J for an I by J two dimensional image array, wherein i, j, I, and J are positive integers and b₁, . . . , bₙ are bytecode values as assigned to n-grams. In one example shown in FIGS. 4B-4C, 6-grams (n=6) are used to define 6-channel images. Assignments of the first three 6-grams to image values B₁₁, B₁₂, B₁₃, and B₁₄ are shown. If a bytecode sequence is not long enough to fill an entire image array, the rest of the array values can be set to zero or other constant. Alternatively, if the bytecode sequence is too long for a single image with the predetermined I by J dimensions and a selected n-gram length, the bytecode sequence can be split to form multiple images, different values of I and J can be selected, or a longer n-gram can be used.

The sequential arrangement of bytecode to n-grams and n-grams to an image array is provided as an example. Any assignments of bytecodes to n-grams and n-grams to image arrays that is performed in the same way to all test bytecode used for training can be used and evaluation of bytecode of new websites can be performed with the same arrangement. Two dimensional arrays are convenient but 1, 2, 3 or higher dimensional arrays can be used as well. It will be appreciated that the sequential arrangement and assignment to n-channel image does not require data storage in any particular order but instead corresponds to logical arrangements used in machine learning processes.

The n-channel images such as illustrated in FIGS. 4B-4C associated with the assignment of bytecode to an n-channel image (or images) are provided to a machine learning data set. For example, a convolutional neural network (CNN) can be used in which there are direct connections from an input layer to fully connected layers that bypass the convolutional layers. CNNs tend to identify fine-grain characteristics in two-dimensional, n-channel images formed from bytecode n-grams. In one example, using classification based on specific byte sequences, a CNN can be defined with direct connections from an input layer to fully connected layers that bypass convolutional layers.

### Example 5. Classification Using Intermediate Representations, URLs, and HTML

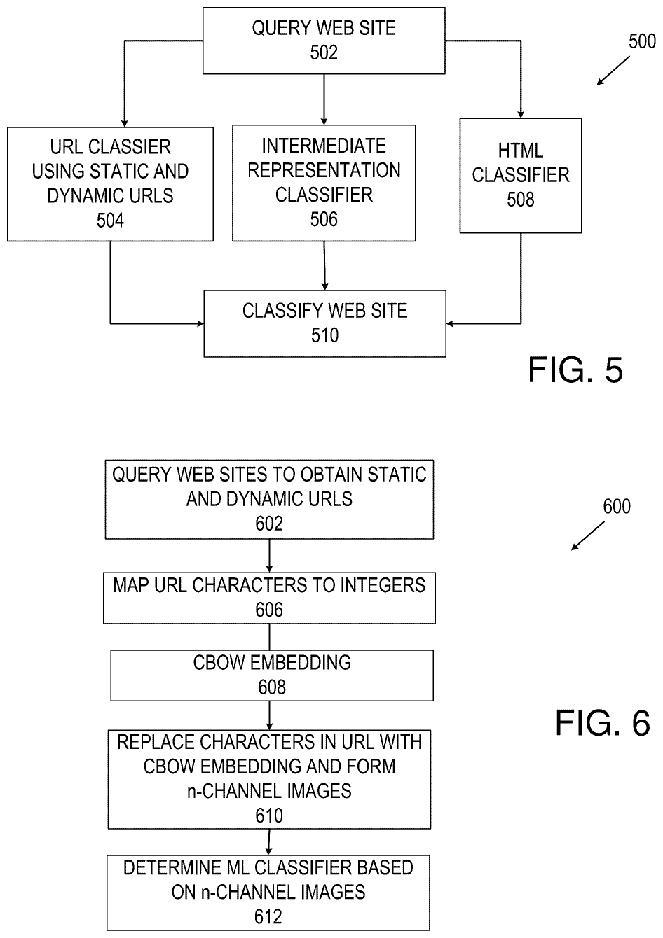

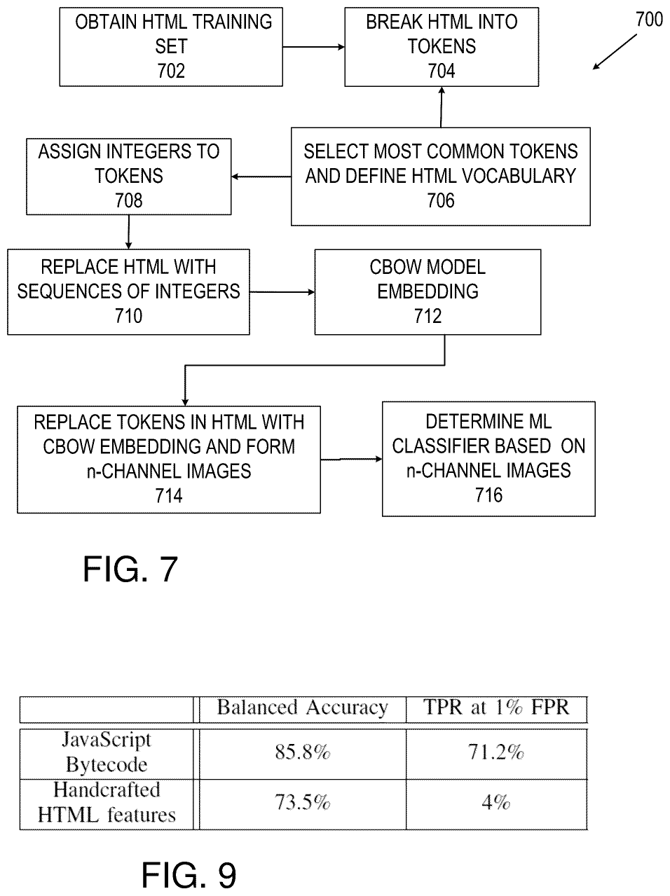

Malicious websites do not always contain malicious JavaScript programs or program segments. In many cases, such as phishing scams, what makes a website malicious is not the functionality implemented by the source program but the deceptiveness of its presentation. A malicious website may be designed to trick users into believing it is a credible source of information, an official website that it is attempting to mimic, or a safe and reliable file-sharing platform, etc. Therefore, in identifying malicious websites, HTML content can also be used in conjunction with intermediate representation-based classification. Selected or learned features from HTML content can be provided to an additional ML model for establishment of a suitable ML algorithm associated with HTML content. A general approach is illustrated in FIG. 5. Referring to FIG. 5, a method 500 of classifying a website includes querying the website at 502. A classifier based on static and dynamic URLs can be applied at 504, if deemed appropriate. At 506 an intermediate representation based classifier is applied. Finally, at 508, an HTML-based classifier is applied and a website classification is provided at 510 based on a combination of URL, HTML, and intermediate representation based classifiers.

### Example 6. Static and Dynamic JavaScript Source URL Classification

In the examples disclosed above, webpages are accessed with a modified version of a web browser such as the Chrome web browser which is operational to interpret and execute JavaScript programs as in normal operation. Any program segments that are to be loaded dynamically at runtime rather than upfront or during parsing are interpreted into bytecode and assigned source URLs which can also be collected. These dynamic URLs obtained when extracting bytecodes and static URLs such as those embedded in a program source or HTML are mapped to embeddings using a Continuous Bag of Words (CBOW) approach. Each character from each of the URLs is considered a token and mapped to an integer in a range [0; 70] which is then mapped to a more meaningful embedding that encodes semantic relationships between tokens. Each URL's embeddings are then used to set values in one row of an n-channel image, with the remaining pixel values at the end of the row set to zero. These images are of a fixed size, but if there are more URLs than rows in the image, the remaining URLs are ignored. URLs obtained from the interpreter can be especially important as malicious website authors may try to evade detection by encoding malicious links in a web page in a way that would not be detected by static malicious URL detectors because they do not appear as they normally should in a web page, and therefore are not examined at all. At run time, these URLs are decoded and used to access malicious resources. However, in the disclosed approaches, such obfuscated URLs are treated as URLs that occur in a web page normally and are examined. Other examples and features useful for URL classifiers are disclosed in Y. Li et al., “A stacking model using URL and HTML features for phishing webpage detection,” Future Generation Computer Systems, vol. 94, pp. 27-39, 2019 (hereinafter “Li”) along with a machine learning approach such as described and Opara et al., “Htmlphish: Enabling phishing web page detection by applying deep learning techniques on html analysis,” 2020 International Joint Conference on Neural Networks (IJCNN), 2020, pp. 1-8 (hereinafter “Opara”), both of which are incorporated herein by reference.

Referring to FIG. 6, a representative method 600 includes obtaining static and dynamic URLs at 602 and mapping characters in URLs to integers at 606. The integers are mapped to an embedding that encodes semantic relationships between characters using the CBOW Model at 608. Each character in the URL is replaced with a corresponding embedding obtained from the CBOW Model and the embeddings are assigned to n-channel images as discussed above at 610, and an ML classifier is determined at 612 based on n-channel images associated with a training set comprising a plurality of URLs having known classifications. After the ML classifier is established, it can be used to classify unknown URLs alone or in combination with other classifiers as shown in FIG. 5.

### Example 7. HTML Classifier

Unlike JavaScript, HTML is not converted into bytecode before being rendered by the Chrome web browser. Therefore, a mix of features such as those described in Li above are used along with a machine learning approach such as that described in Opara. In a first stage of a representative HTML-based method 700, HTML sequences (hereinafter “HTMLs”) with predetermined classifications are assigned as a training set at 702, and at 704, the HTMLs of the training set are broken into tokens using any punctuation or whitespace as delimiters. Unique items in the set of tokens across all HTMLs are then counted and the most frequent 200,000 are used to form a vocabulary at 706 which, arbitrarily, maps these tokens to an integer in a range [1, 200, 000] at 708, reserving 0 (or other integer) for all tokens which are not in the vocabulary. Each HTML is then replaced with these sequences of numbers in a range [0, 200,000] based on the mapping corresponding to their sequences of integers at 710. These sequences can them be used to learn a not-at-all arbitrary embedding that encodes semantic relationships between tokens using the CBOW Model at 712. Each token in the HTML is replaced with a corresponding embedding obtained from the CBOW Model at 714, and these embeddings are placed in n-channel images (as done with the bytecode classifier) to train a CNN or other classifier at 716.

### Example 8. Computer and Networking Environment

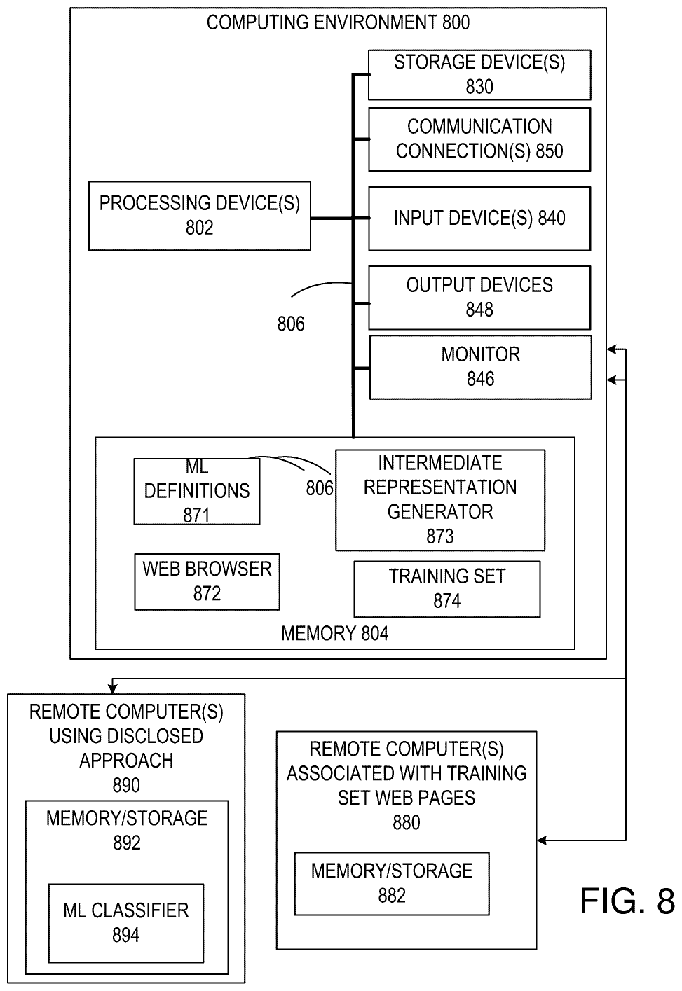

FIG. 8 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC) or other logic device. Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like as well as with FPGAs, ASICs, Complex Programmable Logic Devices (CPLDs), or other dedicated processors. The disclosed technology may also be practiced in distributed computing environments where tasks are performed by remote processing devices that are linked through a communications network. In a distributed computing environment, program modules may be located in both local and remote memory storage devices. As used herein, storage and storage devices refer to physical devices and not transitory storage or signals.

With reference to FIG. 8, an exemplary system for implementing the disclosed technology includes a general-purpose computing device 800, including one or more processing units 802, a system memory 804, and a system bus 806 that couples various system components including the system memory 804 to the one or more processing units 802. The system bus 806 may be any of several types of bus structures including a memory bus or memory controller, a peripheral bus, and a local bus using any of a variety of bus architectures. The exemplary system memory 804 can include read only memory (ROM) and random-access memory (RAM) and a basic input/output system (BIOS) containing the basic routines that help with the transfer of information between elements within the PC 800, can be stored in ROM. The memory 804 also contains portions 871-874 that include definitions for an ML model such as numbers and connections of layers, computer-executable instructions for a web browser or other program that can extract and process programs associated with URLs to obtain intermediate representations, obtain static and dynamic URLs, HTML programs, and to store training sets associated with ML models using one or more or all of intermediate representations, URLs, and HTML associated with a web page. As shown, a memory portion 871 includes ML definitions and training procedures, portion 872 includes computer-executable instructions for a web browser, portion 873 includes computer-executable instructions for producing intermediate representations (which is some examples is provided by the web browser), and portion 874 stores a training set of one or more of URLs, website HTML, and intermediate representations associated with website source programs.

The exemplary PC 800 further includes one or more storage devices 830. Storage devices can be connected to the system bus 806 by an interface, a magnetic disk drive interface, and an optical drive interface, respectively. The drives and their associated computer-readable media provide nonvolatile storage of computer-readable instructions, data structures, program modules, and other data for the PC 800. Other types of computer-readable media which can store data that is accessible by a PC, such as magnetic cassettes, flash memory cards, RAMs, ROMs, and the like, may also be used in the exemplary operating environment.

A number of program modules may be stored in the storage devices 830 including an operating system, one or more application programs, other program modules, and program data, and typically some or all of the features stored in the memory 804. A user may enter commands and information through one or more input devices 840 such as a keyboard and a pointing device such as a mouse. A monitor 846 or other type of display device is also connected to the system bus 806 via an interface, such as a video adapter. Other output devices 848 such as speakers and printers, may be included.

The computing device 800 is illustrated as in communication with one or more remote computers or computer systems 880 that are associated with web pages in a training set so that the computing device may obtain source programs, URLs, and HTML programs associated with the web pages. After receiving source programs, URLs, and HTML, the computing device 800 determines and ML model and stores ML definitions at 871. These definitions can be provided to one or more user computing devices 880 for classification of websites of interest. In some examples, one or more network or communication connections 850 are included for wired or wireless communication as well as data acquisition and control. The remote computing device 880 may be another PC, a server, a router, a network PC, or a peer device or other common network node, and typically includes many or all of the elements described above relative to the PC 800, although only a memory storage device 882 has been illustrated in FIG. 8. The personal computer 800 and/or the remote computing device 880 can be connected to a local area network (LAN) and a wide area network (WAN). Such networking environments are commonplace in offices, enterprise-wide computer networks, intranets, and the Internet. Additional remote computing devices such as remote computer 890 are coupled to receive the ML classifier for use in accessing unclassified websites and include memory 892 that stores computer-executor instructions for an ML classifier in a memory portion 894.

### Example 9. Representative Implementation

In one demonstration of the disclosed approaches, an ML classifier was trained on a dataset of over 2 million benign and malicious URLs by making a request to each one with a web browser and extracting features as described above. Using a combination of an intermediate representation-based classifier with URL and HTML-based classifiers, balanced accuracy, and a true positive rate (TPR) at 1% false positive rate (FPR) of the two trained models were obtained as shown in FIG. 9. A large portion of the malicious URLs detected by a JavaScript bytecode classifier were not detected by conventional methods.

### Example 10. Classification Interpretation

The inputs to the ML models are individual tokens, so, if an association exists between, for example, a single token or bytecode and malicious classification, then the ML model should “learn” this and provide a proper classification based on this token or bytecode. In practice, it is expected that sets of tokens are associated with maliciousness, but regardless, a specific part of the input rather than the entire input can be identified as malicious using the disclosed approaches. Because the disclosed approaches can rely on this fine-grained information (such as one or a few bytecodes, for example), classification can be traced, in some cases, to a single token as mapped back to the original HTML and/or each bytecode, and in some cases, the bytecode can be mapped back to JavaScript source code. Therefore, if visualization methods based on backpropagation as described in Nie et al., “A theoretical explanation for perplexing behaviors of backpropagation-based visualizations,” Proceedings of the 35th International Conference on Machine Learning, Proceedings of Machine Learning Research, Dy and Krause, eds., vol. 80. PMLR, 10-15 Jul. 2018, pp. 3809-3818 (hereinafter “Nie), which is incorporated herein by reference, are used, features associated with classification as malicious can be mapped back to the original JavaScript source code or HTML. This mapping can used to determine what portion of a given JavaScript or HTML caused a malicious classification and permit better analysis of the suspect web page. This ability to identify specific items resulting in classification as malicious may not be of particular interest to everyday internet users who simply wish to avoid bad actors on the web. However, expert users may want to understand why a particular website received a particular classification. This information can be used for downstream tasks such as improving ML mode by identifying unreliable associations learnt by the model, determining the objective of malicious websites, and understanding the techniques used by malicious website authors to fool visitors or evade detection.

### Representative Disclosure Examples

Example 1 is a method, including, with at least one processor: accessing website source programs associated with a plurality of websites; processing the accessed website source programs associated with the plurality of websites to produce corresponding intermediate representations; and based on the intermediate representations and a machine learning model, defining a website classifier.

Example 2 includes the subject matter of Example 1, and further specifies that the website classifier is configured to identify a selected website as malicious based on an intermediate representation of a website source program associated with the selected website.

Example 3 includes the subject matter of any of Examples 1-2, and further specifies that the website classifier is configured to identify a selected website as harmless based on the intermediate representation of the website source program.

Example 4 includes the subject matter of any of Examples 1-3, and further specifies that the website source programs are based on a JavaScript programming language.

Example 5 includes the subject matter of any of Examples 1-4, and further specifies that the intermediate representations are bytecode representations.

Example 6 includes the subject matter of any of Examples 1-5, and further includes accessing the website source programs with a web browser.

Example 7 includes the subject matter of any of Examples 1-6, and further specifies that the machine learning model is a neural network and the intermediate representations of the website source programs are used to train the neural network to produce the website classifier.

Example 8 includes the subject matter of any of Examples 1-7, and further specifies that the neural network is a convolutional neural network (CNN).

Example 9 includes the subject matter of any of Examples 1-8, and further specifies that input layers of the CNN are directly connected to fully connected layers that bypass convolutional layers of the CNN.

Example 10 includes the subject matter of any of Examples 1-9, and further specifies that the intermediate representations are input to the machine learning model as multi-channel images based on n-grams formed from the intermediate representations, wherein n is an integer greater than Example 1.

Example 11 includes the subject matter of any of Examples 1-10, and further specifies that each of the plurality of websites has a predetermined classification as malicious or harmless.

Example 12 includes the subject matter of any of Examples 1-11, and further includes receiving an intermediate representation associated with a target source program accessed with a target uniform resource locator (URL); and classifying the target source program as malicious or harmless based on the website classifier.

Example 13 includes the subject matter of any of Examples 1-12, and further includes establishing a URL classifier and an HTML classifier based on respective URL and HTML training sets, and.

Example 14 is a method of classifying a target website, including, with a processor: receiving an intermediate representation classifier based on a training set of website intermediate representations; receiving a URL classifier based on URLs associated with a URL training set; receiving an HTML classifier based on HTMLs associated with an HTML training set; contacting a target website; and based on an intermediate representation of a source program associated with the target website, HTML associated with the target website, and at least one URL associated with the target website, classifying the target website as malicious or benign.

Example 15 includes the subject matter of any of Examples 14, and further specifies that the at least one URL associated with the target website includes URLs linked to by the source program or the HTML.

Example 16 includes the subject matter of any of Example 14, and further includes obtaining the source program from the target website and processing the source program to produce the intermediate representation.

Example 17 includes the subject matter of any of Examples 14-16, and further specifies that the intermediate representation of the source program is assigned to form at least one n-channel image and the intermediate representation classifier provides a classification based on the at least one n-channel image.

Example 18 includes the subject matter of any of Examples 14-17, and further specifies that the intermediate representation classifier is based on a convolutional neural network.

Example 19 includes the subject matter of any of Examples 14-18, each of the intermediate representation classifier, the URL classifier, and the HTML classifier process the intermediate representation of a source program associated with the target website, the HTML associated with the target website, and the at least one URL associated with the target website based on respective multi-channel images.

Example 20 includes the subject matter of any of Examples 14-19, and further specifies that the intermediate representation is bytecode associated with a JavaScript programming language.

### CONCLUSION

The above disclosed are methods and apparatus use ML approaches on bytecode or other intermediate representations of source code to establish website classifiers, without using lists of malicious websites or URLs alone. The intermediate-representation-based classifiers are hardware independent as they do not rely on machine-specific code. URL and HTML-based classifications and intermediate representation classifications can be separately established and combined. In establishing ML classifications, a web browser can be modified to provide an intermediate representation for either adding URLs, HTML, source code, or intermediate representations of source code to a training set used in developing an ML model or to provide to a developed ML classifier to apply to a particular website. In the examples, a Chrome web browser is modified to obtain bytecode, extracted URLs (both static and dynamic) are used to establish a URL-based classifier, and an HTML-based classifier is similarly determined. Although the examples are directed to classifying websites as malicious or benign, the disclosed approaches can be used to evaluate macros associated with word processing, spreadsheets, portable document viewing, and other applications (e.g. Microsoft Office macros, PDFs containing JavaScript code, etc.).

In view of the many possible embodiments to which the principles of the disclosure may be applied, it should be recognized that the illustrated embodiments are only preferred examples and should not be taken as limiting in scope.

We claim:

1. A method, comprising, with at least one processor:
accessing website source programs associated with a plurality of websites;
processing the accessed website source programs associated with the plurality of websites to produce corresponding intermediate representations; and
based on the intermediate representations and a machine learning model, defining a website classifier.

2. The method of claim 1, wherein the website classifier is configured to identify a selected website as malicious based on an intermediate representation of a website source program associated with the selected website.

3. The method of claim 2, wherein the website classifier is configured to identify a selected website as harmless based on the intermediate representation of the website source program.

4. The method of claim 1, wherein the website source programs are based on a JavaScript programming language.

5. The method of claim 4, wherein the intermediate representations are bytecode representations.

6. The method of claim 1, further comprising accessing the website source programs with a web browser.

7. The method of claim 1, wherein the machine learning model is a neural network and the intermediate representations of the website source programs are used to train the neural network to produce the website classifier.

8. The method of claim 7, wherein the neural network is a convolutional neural network (CNN).

9. The method of claim 8, wherein input layers of the CNN are directly connected to fully connected layers that bypass convolutional layers of the CNN.

10. The method of claim 1, wherein the intermediate representations are input to the machine learning model as multi-channel images based on n-grams formed from the intermediate representations, wherein n is an integer greater than 1.

11. The method of claim 1, wherein each of the plurality of websites has a predetermined classification as malicious or harmless.

12. The method of claim 1, further comprising:
receiving an intermediate representation associated with a target source program accessed with a target uniform resource locator (URL); and
classifying the target source program as malicious or harmless based on the website classifier.

13. The method of claim 1, further comprising establishing a URL classifier and an HTML classifier based on respective URL and HTML training sets, and.

14. A method of classifying a target website, comprising, with a processor:
receiving an intermediate representation classifier based on a training set of website intermediate representations;
receiving a URL classifier based on URLs associated with a URL training set;
receiving an HTML classifier based on HTMLs associated with an HTML training set;
contacting a target website; and
based on an intermediate representation of a source program associated with the target website, HTML associated with the target website, and at least one URL associated with the target website, classifying the target website as malicious or benign.

15. The method of claim 14, wherein the at least one URL associated with the target website includes URLs linked to by the source program or the HTML.

16. The method of claim 14, further comprising obtaining the source program from the target website and processing the source program to produce the intermediate representation.

17. The method of claim 14, wherein the intermediate representation of the source program is assigned to form at least one n-channel image and the intermediate representation classifier provides a classification based on the at least one n-channel image.

18. The method of claim 17, wherein the intermediate representation classifier is based on a convolutional neural network.

19. The method of claim 14, each of the intermediate representation classifier, the URL classifier, and the HTML classifier process the intermediate representation of a source program associated with the target website, the HTML associated with the target website, and the at least one URL associated with the target website based on respective multi-channel images.

20. The method of claim 14, wherein the intermediate representation is bytecode associated with a JavaScript programming language.
